(19) United States
(12) Patent Application Publication
(10) Pub. No.: US 2005/0031782 A1
(43) Pub. Date: Feb. 10, 2005

(54) Coating method

(76) Inventor: Dean A. Foster, Loughborough (GB)

Correspondence Address: MANELLI DENISON & SELTER, 2000 M STREET NW SUITE 700, WASHINGTON, DC, 20036-3307, US

(21) Appl. No.: 10/912,070

(22) Filed: Aug. 6, 2004

(30) Foreign Application Priority Data
Aug. 9, 2003 (GB) 0318754.9

(51) Int. Cl. B05D 3/12

(52) U.S. Cl. 427/240; 427/346

(57) ABSTRACT

A method of coating a complex shaped product such as a nozzle guide vane of a gas turbine engine. The method comprising supplying a coating material into the interior of the vane 10. Locating the vane 10 on a rotating table 14 before the coating material is fully bonded on to the vane 10, and spinning the table 14 to remove excess coating material from the vane 10.

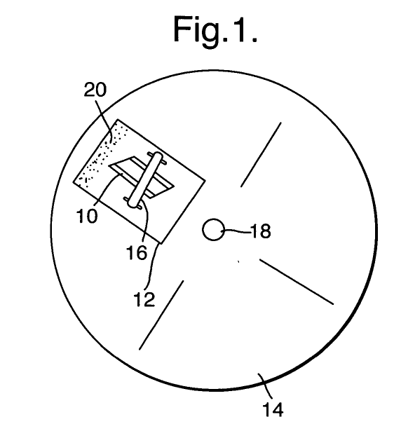

This invention concerns a method of coating a complex shaped product, particularly but not exclusively a component of a gas turbine engine, and especially a nozzle guide vane of such an engine.

Difficulties can be encountered in coating complex shaped products and particularly the interior of complex shaped products where an excess of coating material may build up leading to blockage of the product. Such a product could be the internal aerofoil of a nozzle guide vane of a gas turbine engine. For example in a marine environment, coating of the interior of this product would be required to provide protection from sulphidation and/or corrosion. If excess coating material solidifies in the product, it can be very difficult to subsequently remove, and particularly, if the coating material solidifies to a hard product.

According to the present invention there is provided a method of coating a complex shaped product, the method comprising applying a coating material onto the product, and subsequently spinning the product before the coating material is fully bonded onto the product to remove excess coating material therefrom.

The invention also provides a method of coating the interior of a complex shaped product, the method comprising applying a coating material into the interior of the product, and subsequently spinning the product before the coating material is fully bonded onto the product to remove excess coating material from the interior of the product, by virtue of the centrifugal forces acting thereon during the spinning.

The product may be a component of a gas turbine engine, and may comprise a nozzle guide vane.

During spinning, the nozzle guide vane may be positioned substantially horizontally, and may have the trailing edge region thereof located radially outwards.

The product may be spun about an axis spaced from the product. The product may be mounted on a rotating table, and may be spun in a receptacle to receive excess coating material urged from the product by centrifugal force.

The product may be spun at a speed of between 20 and 500 rpm, preferably between 30 and 200 rpm, and desirably at between 50 and 100 rpm. The coating material may be a slurry material and may comprise aluminising slurry. The coating material may be water based.

The coating material may include a wetting agent. The coating material may be of a type which diffuses with the product.

An embodiment of the present invention will now be described by way of example only and with reference to the single FIGURE of the drawings, which is a diagrammatic plan view of a method according to the invention being carried out.

The internal aerofoil of a nozzle guide vane 10 of a marine gas turbine engine required a protective coating to avoid sulphidation and corrosion. An aluminising water based slurry was used as a coating as follows. The slurry was thinned with 10% water and 1% wetting agent, to improve flow.

The material was supplied into the internal aerofoil using for instance a syringe. The nozzle guide vane 10 was then located in an open topped receptacle 12 mounted on a rotating table 14 by a clamp 16. The nozzle guide vane 10 was mounted in a horizontal position with the trailing edge region of the vane 10 located radially outwards. The vane 10 was mounted spaced approximately 275 mm from the centre 18 of the table 14.

The table 14 was spun at a speed of between 50 and 100 rpm for a required period of time. During spinning, excess coating material 20 is urged by centrifugal forces off the nozzle guide vane 10 and collects in the radially outer end of the receptacle 12.

The aluminising slurry diffuses onto the nozzle guide vane 10, and the thickness of the coating depends upon the time and temperature during which the material is in contact with the nozzle guide vane 10. Following spinning, heat treatment is applied to the nozzle guide vane 10.

There is thus described a method of coating a complex shaped product such as a nozzle guide vane where a required thickness of coating is applied to the product, and excess coating material is removed whilst still liquid, even from a complex shaped article. This avoids having to try and remove the coating material which may for example block some of the internal cavities of the vane 10, following solidification of the material, which can be an extremely difficult task.

It is to be realised that the speed and time of the spinning can be determined to suit the requirements of various components, and so as to remove excess coating material but without affecting the coating which has taken place. The distance from the centre of the table can also be varied as required.

Various modifications may be made without departing from the scope of the invention. For example, the invention can be used for different products and/or a different coating material. The product may be spun in a different manner.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of coating a complex shaped product, the method comprising applying a coating material onto the product, and subsequently spinning the product before the coating material is fully bonded onto the product to remove excess coating material therefrom.

2. A method of coating the interior of a complex shaped product, the method comprising applying a bondable coating material into the interior of the product, and subsequently spinning the product before the coating material is fully bonded onto the product to remove excess coating material from the interior of the product, by virtue of the centrifugal forces acting thereon during the spinning.

3. A method according to claims 1, wherein the product is a component of a gas turbine engine, and comprises a nozzle guide vane.

4. A method according to claim 3, wherein during spinning, the nozzle guide vane is positioned substantially horizontally, and has the trailing edge region thereof located radially outwards.

5. A method according to claim 1, wherein the product is spun about an axis spaced apart from the product.

6. A method according to claim 1, wherein the product is mounted on a rotating table.

7. A method according to claim 1, wherein the product is spun in a receptacle to receive excess coating material urged from the product by centrifugal force.

8. A method according to preceding claim 1, in which the product is spun at a speed of between 20 and 500 rpm.

9. A method according to claim 8 in which the product is spun at a speed of between 30 and 200 rpm.

10. A method as claimed in claim 9 in which the product is spun at a speed of between 50 and 100 rpm.

11. A method according to claim 1, in which the coating material is an aluminising slurry.

12. A method according to claim 1, wherein the coating material is water based.

13. A method according to claim 1, wherein the coating material includes a wetting agent.

14. A method according to claim 1, wherein the coating material is of a type which diffuses with the product.
